(19) United States
(12) Patent Application Publication
(10) Pub. No.: US 2026/0119636 A1
(43) Pub. Date: Apr. 30, 2026

(54) FACIAL-RECOGNITION-BASED INITIALIZATION OF DEVICE RANGING FOR DIGITAL KEY EXCHANGE

(71) Applicant: Motorola Mobility LLC, Chicago, IL (US)

(72) Inventor: Ranjeet Gupta, Aurora, IL (US)

(73) Assignee: Motorola Mobility LLC, Chicago, IL (US)

(21) Appl. No.: 18/930,854

(22) Filed: Oct. 29, 2024

(51) Int. Cl. G06F 21/44; G06F 3/01; G06F 3/0346; G06V 40/16; G06V 40/18

(52) U.S. Cl. CPC G06F 21/44; G06F 3/017; G06F 3/0346; G06V 40/172; G06V 40/197

(57) ABSTRACT

In aspects of facial-recognition-based initialization of device ranging for digital key exchanges, authentication data is received during a scan event via a camera system of a mobile device. The authentication data can be associated with a facial template or iris template that has previously been associated with biometric access to the mobile device or applications thereon. In addition, the mobile device determines the scan distance at which the authentication data was obtained. Based on successful authentication of the authentication data and the scan distance satisfying a predetermined distance threshold, the mobile device performs device ranging in association with a digital key exchange with the secured area.

### BACKGROUND

With the advancement of technology, electronic devices have become a common part of our daily lives. For example, many people carry cell phones and smartwatches throughout the day. These electronic devices can serve as digital keys, providing passive access to various devices and spaces such as lockers, home security systems, and automobiles. However, when the user is near the protected area (e.g., in a garage near their parked vehicle), the electronic devices repeatedly attempt to unlock the protected area even if the user does not intend to access it. The repeated and unnecessary attempts to provide passive entry leads to accidental unlocking and drainage of the electronic device's battery.

### BRIEF DESCRIPTION OF THE DRAWINGS

Aspects of facial-recognition-based initialization of device ranging for digital key exchange are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of facial-recognition-based initialization of device ranging for digital key exchanges can be implemented;

FIG. 2 depicts an example system in which aspects of facial-recognition-based initialization of device ranging for digital key exchanges can be implemented;

FIG. 3 depicts an example flow diagram in which aspects of facial-recognition-based initialization of device ranging for digital key exchanges can be implemented for a locked mobile device;

FIG. 4 depicts an example flow diagram in which aspects of facial-recognition-based initialization of device ranging for digital key exchanges can be implemented for an unlocked mobile device;

FIG. 5 depicts an example procedure for facial-recognition-based initialization of device ranging for digital key exchanges in accordance with one or more implementations; and

FIG. 6 illustrates various components of an example electronic device that can implement embodiments of the techniques described herein.

### DETAILED DESCRIPTION

Facial-recognition-based initialization of device ranging for digital key exchanges is discussed herein. Digital key technology allows users to securely and conveniently access devices (e.g., smartphones, laptops, automobiles) or spaces (e.g., lockers, homes, elevators, business offices) using digital credentials or keys stored on electronic devices rather than using traditional physical keys, key cards, or fobs. A digital key includes a unique code or data set for accessing the protected area and is generally linked to a specific user or electronic device. The digital key is stored securely on the user's electronic device. When the user approaches the protected area equipped with digital key technology, the protected area requests that the user's electronic device provide the digital key. Upon verifying the authenticity and validity of the digital key, the user is granted access to the protected area.

However, in several frequent scenarios, the user or the user's electronic device is near the protected area when the user does not intend to enter the protected area. For example, the user is working in or passing through their garage where their vehicle is parked, roaming (e.g., mowing the grass or chatting with neighbors) in their front lawn, sitting in a room near the garage or driveway, or sitting next to the protected area. In these situations, the electronic device enters an active-ranging mode to accurately determine the distance between the digital key (e.g., the user's electronic device) and the receiver (of the protected area), unnecessarily draining the electronic device's battery. If the digital key is near enough to the receiver, the protected area will be unlocked (or repeatedly unlocked as the user enters and leaves the threshold range), potentially creating security concerns by accidental unlocks.

To address these problems, the described techniques and systems for facial-recognition-based initialization of device ranging for digital key exchanges avoid these common issues. For instance, an electronic device typically includes user authentication capability to request authentication information before a user is granted access to functionality of the electronic device. Because many modern devices include biometric sensors (e.g., front-facing camera systems for facial or iris scans) which collect biometric information (e.g., facial or iris recognition data) for use in authenticating a user, the proposed techniques utilize this user authentication capability to infer a user's intent to use their stored digital key and access a protected area. The electronic device associate a biometric template in combination with a distance or range threshold with digital key services. Once the electronic device authenticates the user with the biometric template (e.g., facial or iris recognition) from within the specified distance threshold (e.g., using a infrared (IR) sensor or time-of-flight calculations), the electronic device performs device ranging and passive unlocking. In this way, the electronic device avoids unnecessary battery drainage from repeated ranging attempts and unwanted unlocking.

While features and concepts of the described techniques for facial-recognition-based initialization of device ranging for digital key exchanges can be implemented in any number of different devices, systems, environments, and/or configurations, implementations of the techniques and systems for facial-recognition-based initialization of device ranging for digital key exchanges are described in the context of the following example devices, systems, and methods.

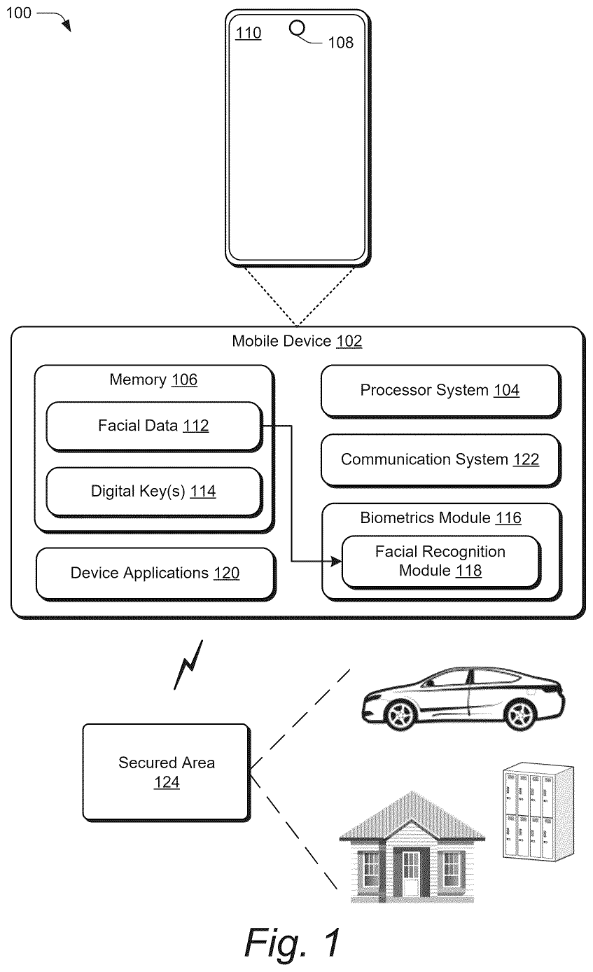

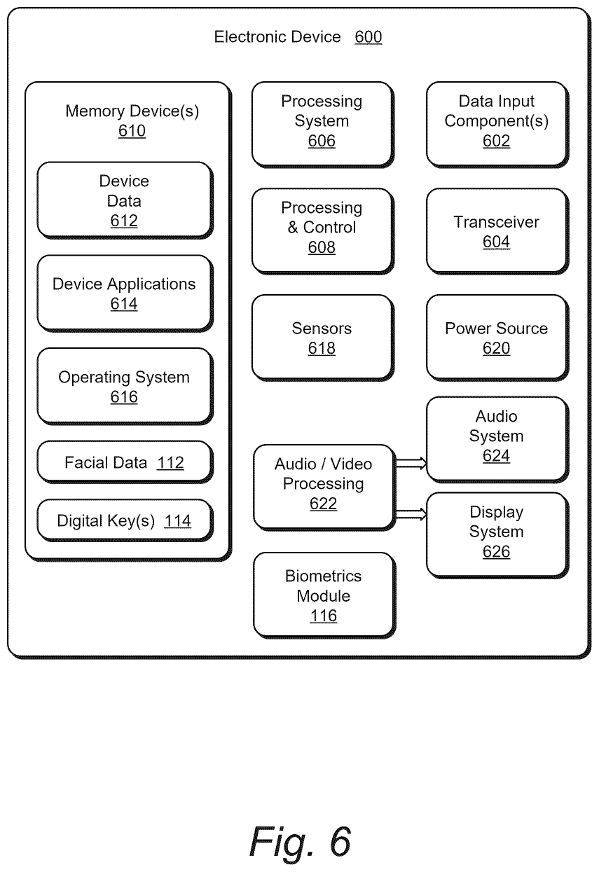

FIG. 1 illustrates an example environment 100 in which aspects of facial-recognition-based initialization of device ranging for digital key exchanges can be implemented. The environment 100 includes a mobile device 102, which may be any type of mobile phone, smartphone, flip phone, computing device, tablet device, smartwatch, and/or any other type of mobile device. Generally, the mobile device 102 may be any electronic, computing, and/or communication device implemented with various components, such as a processor system 104 and memory 106, as well as any number and combination of different components as further described with reference to the example device shown in FIG. 6.

The mobile device 102 includes a camera 108, which, when turned on, collects image data of the user's face and/or eyes that can be used to authenticate the user. In one or more implementations, the camera 108 is an under-display component in which a display 110 is the topmost layer of the mobile device 102, and the camera 108 is located between the display 110 and the back housing of the mobile device 102. As shown, the camera 108 is illustrated as at the top center of the front face of the mobile device 102, but the placement on the front face or another face of the mobile device 102 can vary. Additionally or alternatively, the camera 108 is an integrated component of a front housing of the mobile device 102 proximate the display 110, and as such, is not a component of or within the display 110. It is to be appreciated that camera 108 can be any type of camera system combined with a depth sensor to measure the space between the user's face and the camera 102 to capture three-dimensional features (e.g., infrared sensor or time-of-flight module). Further, the display 110 represents functionality (e.g., hardware and logic) for enabling visual output of content by the mobile device 102 (e.g., via a user interface), and in various implementations, the display 110 is a touch-sensitive display, enabling receipt of touch inputs via the display 110.

Memory 106 is illustrated as maintaining known facial data 112, which is facial recognition data associated with a user that is authorized to access the functionality and content of the mobile device 102. Broadly, when access to secure content and/or secure functionality of the mobile device 102 is requested (e.g., a user attempts to unlock the mobile device 102 or access a secure device application), facial recognition data is collected via the camera 108 and compared to the known facial data 112. If the collected facial recognition data matches the known facial data 112, then access to the requested content and/or requested functionality is granted. The known facial data 112 includes facial feature data associated with any number of users authorized to access the functionality and content of the mobile device 102. In at least one implementation, the facial data 112 includes iris feature data associated with the left and/or right eye of any number of users authorized to access the functionality and content of the mobile device 102.

The memory 106 is further illustrated as including one or more digital keys 114, which are software-based electronic representations of traditional physical keys for a secured area 124 (e.g., an automobile, locker, or home security system). In other implementations, the digital keys 114 are stored in a secure element, which may be separate from the general memory of the mobile device 102. For example, the secure element can be an embedded secure element (eSE), which is a tamper-resistant hardware device, such as a smart card chip that includes its own integrated processor, memory (e.g., ROM, EEPROM, RAM), and an I/O port for tamper-proof connectivity and data communication with other hardware devices implemented in the mobile device 102.

The digital keys 114 are stored in the memory 106 and can be secured application data, digital certificates, or tokens. Each digital key 114 includes a unique identifier that distinguishes it from other digital keys 114 for the same secured area 124. By way of example and not limitation, the secured area 124 includes an automobile, locker, home security system, electronic device (e.g., computer or server), hotel room, office security system, and so on. The mobile device 102 or device application 120 associated with the secured area 124 uses a digital key 114 to unlock or permit access to the secured area 124.

The mobile device 102 also includes a biometrics module 116, which includes a facial recognition module 118. The biometrics module 116 is hardware, software, or combination thereof in the mobile device 102 to authenticate users based on unique physical characteristics to enhance security and provide convenient access to the mobile device 102 and device applications 120. Common types of biometrics used by the biometrics module 116 includes fingerprints, facial recognition, voice recognition, and/or iris recognition. In the illustrated implementation of mobile device 102, the biometrics module 116 utilizes the facial recognition module 118 to manage access rights.

The camera108 collects authentication data during a scan event. The authentication data associated with the scan event is provided to the facial recognition module 118, which attempts to authenticate the authentication data. The facial recognition module 118 compares the authentication data to the known facial data 112. If a match is found in the known facial data 112, then the facial recognition module 118 outputs a successful authentication of the scan event.

The mobile device 102 also includes one or more device applications 120 and communication system(s) 122. The device applications 120 are software applications designed to exchange or send (e.g., using the communication system 122) the digital key 114 associated with a particular secured area 124 to a receiver of an electronic device associated with the secured area 124. Upon authentication and verification of the digital key 114, the secured area 124 is unlocked or otherwise permits access to a user of the mobile device 102.

The communication system 122 includes communication transceivers that enable wireless communication of the digital keys 114 with other devices (e.g., associated with the secured area 124). Example transceivers include wireless personal area network (WPAN) radios compliant with various IEEE 802.15 (Bluetooth™) standards, wireless radios compliant with various IEEE 802.15.4 (Ultra-Wideband™) standards wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

Conventional techniques for exchanging digital keys 114 involve the mobile device 102 using the communication system 122 to perform range scanning to determine the distance between the mobile device 102 and the secured area 124. In some implementations, the range scanning is performed periodically or in response to detecting user steps to obtain an initial separation distance. This initial ranging is often performed using Bluetooth Low Energy™ (BLE) or Wi-Fi™ signals (e.g., via received signal strength indicator (RSSI) signals). When the separation distance is determined to be below a first threshold distance (e.g., 10 meters), the conventional techniques trigger fine timing measurements (FTM) via UWB to improve the ranging accuracy. UWB ranging continues until the separation distance is below a second threshold distance (e.g., several meters), which triggers the secured area 124 (e.g., a vehicle) to unlock. As described above, these conventional techniques result in unnecessary and unattended UWB ranging and unlocking of the secured area 124 in many scenarios, resulting in extra battery usage and potential security concerns.

In accordance with the described techniques, UWB ranging and the exchange of digital keys 114 is triggered by biometrics authentication. Without the below-described user authentication, the UWB ranging and digital key exchange are not triggered, preventing unwanted battery usage and unlocking. In one implementation, the biometrics authentication to initiate the digital key change process is associated with a facial or iris scan from within a threshold distance of the user.

Having discussed an example environment in which the disclosed techniques can be performed, consider now some example scenarios and implementation details for implementing the disclosed techniques.

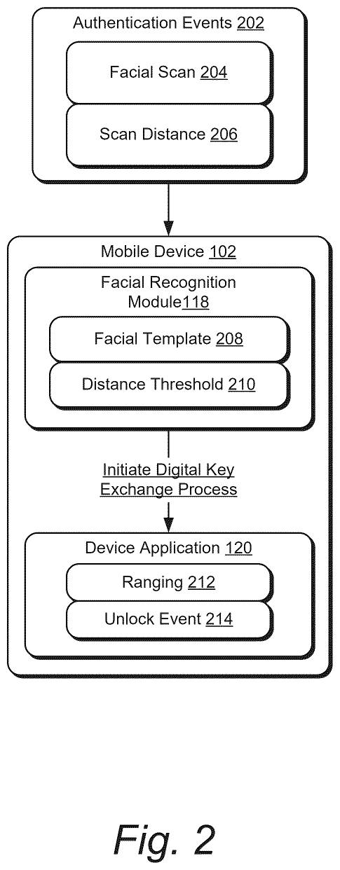

FIG. 2 depicts an example system 200 in which aspects of facial-recognition-based initialization of device ranging for digital key exchanges can be implemented. By way of example, the camera 108 receives authentication events 202 including a facial scan 204 and a scan distance 206. Although illustrated as including facial recognition data, it is to be appreciated that authentication events 202 can include another biometric input (e.g., iris recognition) with the camera 108, another biometric input (e.g., voice recognition) with another sensor, or a combination thereof.

The facial scan 204 is associated with facial features specifically enrolled by the user of the mobile device 102 to initiate the digital key exchange process with one or more secured areas 124 if the scan distance 206 associated with the authentication event 202 satisfies a predetermined range or distance threshold. In other words, the facial scan 204, if taken from within a certain range of the mobile device 102, initiates the digital key service for one or more secured areas 124.

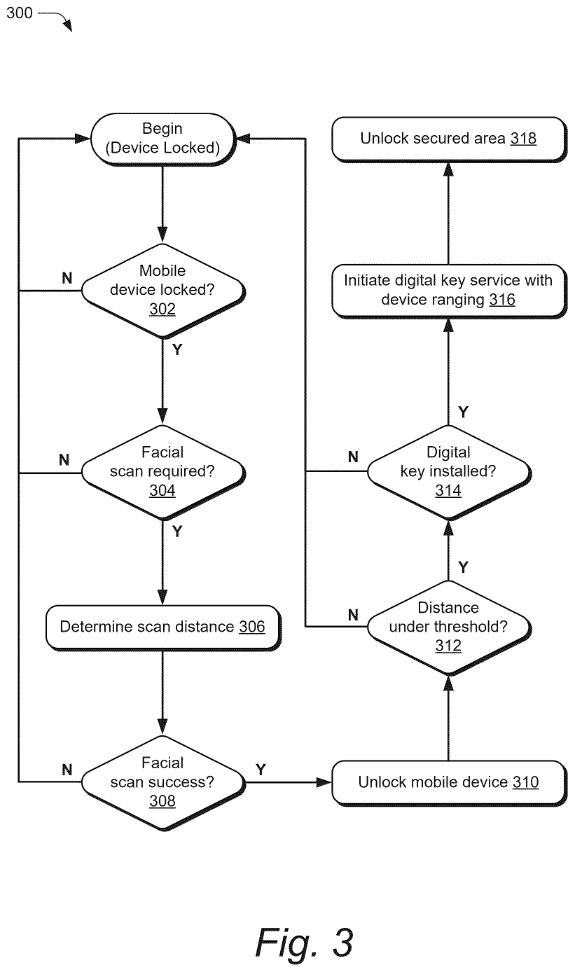

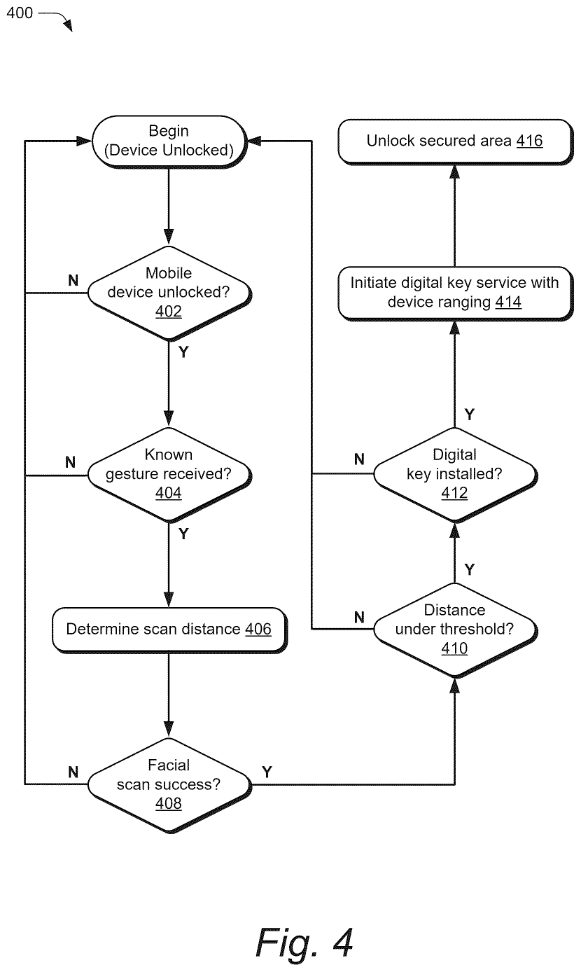

The facial recognition module 118 receives the authentication event 202 and determines whether the facial scan 204 from the scan distance 206 satisfies both facial recognition requirements and distance thresholds to initiate the digital key exchange process. In one implementation, if the authentication event 202 includes a facial scan 204 authenticated by a facial template 208 of the facial recognition module 118 and the scan distance 206 satisfies the distance threshold 210, the facial recognition module 118 initiates a digital key exchange process, which triggers ranging 212 by a device application 120 associated with the secured area 124. In other words, the facial scan 204 unlocks the mobile device 102 and/or initiates the device ranging 212 (e.g., via a UWB transceiver). In this way, the mobile device 102 receives a reliable indication of the user's intent to access the secured area 124 associated with the facial scan 204 by assessing the scan distance 206 before initiating the digital key exchange process with ranging 212 and an unlock event 214. Accordingly, the digital key exchange is sandboxed or isolated from general facial scans to generally unlock the device or access certain features or applications. The unlock event is described in more detail with respect to FIGS. 3 and 4.

FIG. 3 depicts an example flow diagram 300 in which aspects of facial-recognition-based initialization of device ranging for digital key exchanges can be implemented for a locked mobile device. At 302, it is determined whether the mobile device is locked. By way of example, the mobile device 102 or a device application 120 determines whether the mobile device is locked (e.g., in a locked state with limited access available to the user). In response to the mobile device 102 not being locked (e.g., a “no” determination at block 302), the mobile device 102 or device application 120 returns to the beginning of the flow diagram 300.

At 304, in response to the mobile device 102 being locked (e.g., a “yes” determination at block 302), it is determined whether a facial scan or iris scan is required to unlock the mobile device 102. By way of example, mobile device 102 or device application 120 verifies that the user has enabled facial scan 204 or an iris scan to unlock mobile device 102 as a biometric feature recognition. In response to the mobile device 102 not requiring or enabling a facial scan to unlock the device (e.g., a “no” determination at block 304), the mobile device 102 or device application 120 returns to the beginning of the flow diagram 300.

At 306, in response to the mobile device 102 requiring or enabling a facial scan to unlock the device (e.g., a “yes” determination at block 304), distance scanning means are enabled and a determination is made on the distance between the user's face and the camera in the mobile device 102. By way of example, the mobile device 102 or the device application 120 enables an IR sensor to measure the scan distance 206 via a time-of-flight calculation. In another implementation, the mobile device 102 includes diffractive optical element (DOE) screen and infers the scan distance 206 based on refraction pattern of returned light from the user's face.

At 308, it is determined whether the facial scan was successful. By way of example, the mobile device 102 or device application 120 determines whether the facial scan 204 or iris scan matches a facial template 208 or iris template, respectively, stored in the secure memory of the mobile device 102. In response to the facial or iris scan not successfully unlocking the device (e.g., a “no” determination at block 308), the mobile device 102 or device application 120 returns to the beginning of the flow diagram 300. In another implementation and in response to an unsuccessful scan, the mobile device may perform another facial or iris scan (or a predefined number of attempts) before returning to the beginning of the flow diagram 300.

At 310, in response to the facial or iris scan successfully unlocking the mobile device (e.g., a “yes” determination at block 308), the mobile device is unlocked. By way of example, the facial scan 204 or iris scan is used by the facial recognition module 118 to unlock the mobile device 102. At 312, it is determined whether the scan distance 206 satisfies the distance threshold 210. By way of example, the mobile device 102 or device application 120 determines whether the scan distance 206 (e.g., the distance at which the facial scan 204 was taken from the user's face) is under the distance threshold 210 or within a predetermined distance range. In response to the distance scan 206 not being under the distance threshold 210 (e.g., a “no” determination at block 312), the mobile device 102 or device application 120 returns to the beginning of the flow diagram 300. In another implementation and in response to the distance scan not satisfying the distance threshold, the mobile device may perform another facial or iris scan (or a predefined number of attempts) before returning to the beginning of the flow diagram 300 or a previous block.

At 314, it is determined whether a digital key is installed or saved (e.g., in a secure or trusted memory environment) in a mobile device. By way of example, the mobile device 102 or device applications 120 determines whether a digital key 114 is installed or saved on the mobile device 102. In response to a digital key 114 not being installed on the mobile device 102 (e.g., a “no” determination at block 314), the mobile device 102 or device application 120 returns to the beginning of the flow diagram 300. In one implementation, the flow diagram 300 does not initiate unless a digital key is installed on the mobile device 102.

At 316, in response to a digital key being installed on the mobile device (e.g., a “yes” determination at block 314), the mobile device 102 or device application 120 then initiates the digital key exchange process by performing device ranging using an UWB transceiver, Bluetooth channel sounding, or another ranging technique. At 318, the secured area is unlocked. By way of example, once the mobile device 102 is within a distance threshold of the secured area 124, the UWB or NFC transceiver transmits the digital key 114 to a receiver associated with the secured area 124 and, in response to authenticating and verifying the digital key 114, unlocks or grants access to the secured area 124.

FIG. 4 depicts an example flow diagram 400 in which aspects of facial-recognition-based initialization of device ranging for digital key exchanges can be implemented for an unlocked mobile device. At 402, it is determined whether the mobile device is unlocked. By way of example, the mobile device 102 or a device application 120 determines whether the mobile device is unlocked (e.g., in an unlocked state with access available to the user). In response to the mobile device 102 not being unlocked (e.g., a “no” determination at block 402), the mobile device 102 or device application 120 returns to the beginning of the flow diagram 400.

At 404, in response to the mobile device 102 being unlocked (e.g., a “yes” determination at block 402), it is determined whether a known or predetermined gesture was received. By way of example, the mobile device 102 or a device application 120 determines whether a known hardware gesture (e.g., a button press, a button hold for a predetermined amount of time, or a movement of the mobile device 102 near the user's face), software gesture (e.g., opening of a device application 120 associated with a secured area 124), or a combination thereof was received or detected. In response to the mobile device 102 or device application 120 not detecting or receiving a known gesture (e.g., a “no” determination at block 404), the mobile device 102 or device application 120 returns to the beginning of the flow diagram 400 or periodically returns to block 404.

At 406, in response to the mobile device 102 or device application 120 detecting or receiving a known gesture (e.g., a “yes” determination at block 404), distance scanning means are enabled and a determination is made on the distance between the user's face and the camera in the mobile device 102. By way of example, the mobile device 102 or the device application 120 enables an IR sensor to measure the scan distance 206 via a time-of-flight calculation. In another implementation, the mobile device 102 includes diffractive optical element (DOE) screen and infers the scan distance 206 based on refraction pattern of returned light from the user's face.

At 408, it is determined whether the facial scan was successful. By way of example, the mobile device 102 or device application 120 determines whether the facial scan 204 or iris scan matches a facial template 208 or iris template, respectively, stored in the secure memory of the mobile device 102. In response to the facial or iris scan not being successful (e.g., a “no” determination at block 408), the mobile device 102 or device application 120 returns to the beginning of the flow diagram 400, block 402, or block 404. In another implementation and in response to an unsuccessful scan, the mobile device may perform another facial or iris scan (or a predefined number of attempts) before returning to the beginning of the flow diagram 400 or a previous block.

At 410, in response to the facial or iris scan being successful (e.g., a “yes” determination at block 408), it is determined whether the scan distance 206 satisfies the distance threshold 210. By way of example, the mobile device 102 or device application 120 determines whether the scan distance 206 (e.g., the distance at which the facial scan 204 was taken from the user's face) is under the distance threshold 210 or within a predetermined distance range. In response to the distance scan 206 not being under the distance threshold 210 (e.g., a “no” determination at block 410), the mobile device 102 or device application 120 returns to the beginning of the flow diagram 300. In another implementation and in response to the distance scan not satisfying the distance threshold, the mobile device may perform another facial or iris scan (or a predefined number of attempts) before returning to the beginning of the flow diagram 400 or a previous block.

At 412, it is determined whether a digital key is installed or saved (e.g., in a secure or trusted memory environment) in a mobile device. By way of example, the mobile device 102 or device applications 120 determines whether a digital key 114 is installed or saved on the mobile device 102. In response to a digital key 114 not being installed on the mobile device 102 (e.g., a “no” determination at block 412), the mobile device 102 or device application 120 returns to the beginning of the flow diagram 400. In one implementation, the flow diagram 400 does not initiate unless a digital key is installed on the mobile device 102.

At 414, in response to a digital key being installed on the mobile device (e.g., a “yes” determination at block 412), the mobile device 102 or device application 120 then initiates the digital key exchange process by performing device ranging using an UWB transceiver or another ranging technique. At 416, the secured area is unlocked. By way of example, once the mobile device 102 is within a distance threshold of the secured area 124, the UWB or NFC transceiver transmits the digital key 114 to a receiver associated with the secured area 124 and, in response to authenticating and verifying the digital key 114, unlocks or grants access to the secured area 124.

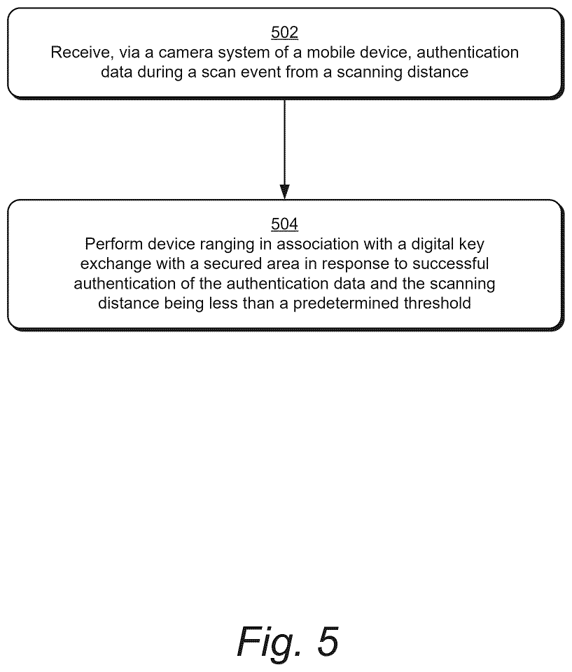

FIG. 5 depicts an example procedure 500 for facial-recognition-based initialization of device ranging for digital key exchanges in accordance with one or more implementations. At 502, authentication data is received via a camera system (e.g., a front-facing camera) of a mobile device during a scan event. The scan event occurs at a scanning distance from the user's face. By way of example, the camera system 108 receives authentication data (e.g., facial scan 204 or an iris scan) during a scan event. The authentication data is associated with the user's facial features or iris. The camera system 108 is integrated in the mobile device 102, which includes, for example, a smartphone, a mobile phone, or a smartwatch.

At 504, device ranging in association with a digital key exchange with a secured area is performed in response to successful authentication of the authentication data and the scanning distance being less than a predetermined threshold. By way of example, the mobile device 102 or one or more device applications 120 cause the communication system 122 to perform device ranging (e.g., using a UWB transceiver) to determine whether the mobile device 102 is sufficiently close to the secured area 124 (or a receiver thereof) to initiate the digital key exchange (e.g., transmit the digital key 114 for the secured area 124 to the receiver associated with the secured area 124). The secured area 124 includes, for example, an automobile, a lock, a locker, a security system, a hotel room, or a smart home device. In response to the device ranging indicating that the mobile device 102 is within a predetermined distance of the secured area 124 (or a receiver thereof), the mobile device 102 or the device application 120 causes the communication system 122 to transmit (e.g., using a UWB or NFC transceiver) the digital key 114 associated with the secured area 124 to a receiver associated with the secured area 124 to unlock or grant access to the secured area 124.

The authentication data is associated with a user's face (e.g., the facial scan 204 of FIG. 2) or iris that the user has registered for biometric access to the mobile device 102 and applications and features thereof. In scenarios where the mobile device 102 is in a locked state, mobile device 102 enters an unlocked state (e.g., unlocks) and performs device ranging in association with the digital key exchange process for the particular secured area in response to successfully authenticating the facial scan 204 (or the iris scan) and the scan distance 206 satisfying the distance threshold 210. In scenarios where the mobile device 102 is in an unlocked state, mobile device 102 initiates the device ranging in response to detecting a predetermined gesture to initiate a facial scan, successfully authenticating the facial scan 204 (or iris scan), and the scan distance 206 satisfying the distance threshold 210.

FIG. 6 illustrates various components of an example electronic device that can implement embodiments of the techniques discussed herein. The electronic device 600 can be implemented as any of the devices described with reference to the previous Figures, such as any client device, mobile phone, tablet, computing, communication, entertainment, gaming, media playback, or other electronic device. In one or more embodiments, the electronic device 600 includes facial data 112, digital keys 114, and biometrics module 116, as described above.

The electronic device 600 includes one or more data input components 602 via which any type of data, media content, or inputs can be received, such as user-selectable inputs, messages, music, television content, recorded video content, and any other type of text, audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device 600 to components, peripherals, or accessories such as keyboards, microphones, or cameras. The data input components 602 may also include various other input components such as microphones, touch sensors, touchscreens, keyboards, and so forth.

The device 600 includes communication transceivers 604 that enable one or both wired and wireless communication of device data with other devices (e.g., associated with a secured area). The device data can include the digital keys 114 or any text, audio, video, image data, or combinations thereof. Example transceivers include wireless personal area network (WPAN) radios compliant with various IEEE 802.15 (Bluetooth™) standards, wireless radios compliant with various IEEE 802.15.4 (Ultra-Wideband™) standards wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 600 includes a processing system 606 of one or more processors (e.g., any of microprocessors, controllers, and the like) or a processor and memory system implemented as a system-on-chip (SoC) that processes computer-executable instructions. The processing system 606 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory devices 610 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 610 include volatile memory and non volatile memory, fixed and removable media devices, and any suitable memory device or electronic data storage that maintains data for computing device access. The computer-readable storage memory can include various implementations of random access memory (RAM), read only memory (ROM), flash memory, and other types of storage media in various memory device configurations. The device 600 may also include a mass storage media device.

The computer-readable storage memory device 610 provides data storage mechanisms to store the device data 612, other types of information or data (e.g., facial data 112 and digital keys 114), and various device applications 614 (e.g., software applications). For example, an operating system 616 can be maintained as software instructions with a memory device and executed by the processing system 606 to cause the processing system 606 to perform various acts. The device applications 614 may also include a device manager, such as any form of a control application, software application, signal-processing and control module, code that is native to a particular device, a hardware abstraction layer for a particular device, and so on.

The device 600 can also include one or more device sensors 618, such as any one or more of an ambient light sensor, a proximity sensor, a camera, a touch sensor, an infrared (IR) sensor, accelerometer, gyroscope, thermal sensor, audio sensor (e.g., microphone), and the like. The device 600 can also include one or more power sources 620, such as when the device 600 is implemented as a mobile device. The power sources 620 may include a charging or power system, and can be implemented as a flexible strip battery, a rechargeable battery, a charged super-capacitor, or any other type of active or passive power source.

The device 600 additionally includes an audio or video processing system 622 that generates one or both of audio data for an audio system 624 and display data for a display system 626. In accordance with some embodiments, the audio/video processing system 622 is configured to receive call audio data from the transceiver 604 and communicate the call audio data to the audio system 624 for playback at the device 600. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for biometric-based initialization of device ranging for digital key exchanges have been described in language specific to features or methods, the subject of the appended claims is not necessarily limited to the specific features or methods described. Rather, the specific features and methods are disclosed as example implementations of techniques for implementing image-based device customization for multiple users. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a mobile device comprising a memory and one or more processors coupled with the memory and configured to cause the mobile device to receive, via a camera system and from a scanning distance, authentication data during a scan event and in response to successful authentication of the authentication data and the scanning distance being less than a predetermined threshold, perform device ranging in association with a digital key exchange with a secured area.

In some aspects, the techniques described herein relate to a mobile device wherein the authentication data is first authentication data received during a first scan event at a first scan distance.

In some aspects, the techniques described herein relate to a mobile device wherein the one or more processors are further configured to cause the mobile device to in response to the mobile device being in a locked state, the successful authentication of the first authentication data, and the first scan distance being less than the predetermined threshold, enter an unlocked state and perform the device ranging in association with the digital key exchange with the secured area.

In some aspects, the techniques described herein relate to a mobile device wherein the one or more processors are further configured to cause the mobile device to in response to the mobile device being in a locked state, the successful authentication of the first authentication data, and the first scan distance being greater than the predetermined threshold, enter an unlocked state and not initiate the device ranging in association with the digital key exchange with the secured area.

In some aspects, the techniques described herein relate to a mobile device wherein the one or more processors are further configured to cause the mobile device to, in response to the mobile device being in the unlocked state and in response to receiving a predetermined gesture, receive, via the camera system and from a second scanning distance, second authentication data during a second scan event and, in response to the successful authentication of the second authentication data and the second scanning distance associated with the second scan event being less than the predetermined threshold, perform the device ranging in association with the digital key exchange with the first secured area.

In some aspects, the techniques described herein relate to a mobile device wherein the predetermined gesture comprises at least one of a hardware gesture input by the user and received by the mobile device, a software gesture input by the user and received by the mobile device, or a combination of the hardware gesture and the software gesture input by the user and received by the mobile device.

In some aspects, the techniques described herein relate to a mobile device wherein the predetermined gesture further comprises the user raising the phone to a vertical orientation in front of a face.

In some aspects, the techniques described herein relate to a mobile device wherein the second scan event occurs a predetermined time after receiving the predetermined gesture.

In some aspects, the techniques described herein relate to a mobile device wherein the authentication data includes data associated with a facial scan or an iris scan.

In some aspects, the techniques described herein relate to a mobile device wherein the scanning distance is determined based on a time-of-flight measurement using an infrared (IR) light sensor or based on an inferred depth position using a diffractive optical element screen associated with the camera system.

In some aspects, the techniques described herein relate to a mobile device wherein the one or more processors are further configured to cause the mobile device to, in response to the device ranging indicating that the mobile device is within a predetermined distance of the secured area, transmit a digital key associated with the secured area to a receiver associated with the secured area to unlock the secured area.

In some aspects, the techniques described herein relate to a mobile device wherein the secured area comprises an automobile, a lock, a locker, a security system, a hotel room, or a smart home device.

In some aspects, the techniques described herein relate to a mobile device wherein the mobile device comprises a smartphone, a mobile phone, or a smartwatch.

In some aspects, the techniques described herein relate to a method comprising receiving, via a camera system and from a scanning distance, authentication data during a scan event and, in response to successfully authenticating the authentication data and the scanning distance being less than a predetermined threshold, performing device ranging in association with a digital key exchange with a secured area.

In some aspects, the techniques described herein relate to a method wherein the authentication data includes data associated with a facial scan or an iris scan and the scanning distance is determined based on a time-of-flight measurement using an infrared (IR) light sensor or based on an inferred depth position using a diffractive optical element screen associated with the camera system.

In some aspects, the techniques described herein relate to a method wherein the authentication data is first authentication data received during a first scan event at a first scan distance and the method further comprises, in response to the mobile device being in a locked state, the successful authentication of the first authentication data, and the first scan distance being less than the predetermined threshold, entering an unlocked state and performing the device ranging in association with the digital key exchange with the secured area.

In some aspects, the techniques described herein relate to a method wherein the authentication data is first authentication data received during a first scan event at a first scan distance and the method further comprises, in response to the mobile device being in a locked state, the successful authentication of the first authentication data, and the first scan distance being greater than the predetermined threshold, entering an unlocked state and not initiating the device ranging in association with the digital key exchange with the secured area.

In some aspects, the techniques described herein relate to a method wherein the method further comprises, in response to the mobile device being in the unlocked state and in response to receiving a predetermined gesture, receiving, via the camera system and from a second scanning distance, second authentication data during a second scan event; and in response to the successful authentication of the second authentication data and the second scanning distance associated with the second scan event being less than the predetermined threshold, performing the device ranging in association with the digital key exchange with the first secured area.

In some aspects, the techniques described herein relate to a method wherein the predetermined gesture comprises at least one of a hardware gesture input by the user and received by the mobile device, a software gesture input by the user and received by the mobile device, or a combination of the hardware gesture and the software gesture input by the user and received by the mobile device.

In some aspects, the techniques described herein relate to a system comprising at least one memory and at least one processor coupled with the at least one memory and configured to cause the system to receive, via a camera system and from a scanning distance, authentication data during a scan event and in response to successful authentication of the authentication data and the scanning distance being less than a predetermined threshold, perform device ranging in association with a digital key exchange with a secured area.

1. A mobile device comprising:
a memory; and
one or more processors coupled with the memory and configured to cause the mobile device to:
receive, via a camera system and from a scanning distance, authentication data during a scan event; and
in response to successful authentication of the authentication data and the scanning distance being less than a predetermined threshold, perform device ranging in association with a digital key exchange with a secured area.

2. The mobile device of claim 1, wherein the authentication data is first authentication data received during a first scan event at a first scan distance.

3. The mobile device of claim 2, wherein the one or more processors are further configured to cause the mobile device to:
in response to the mobile device being in a locked state, the successful authentication of the first authentication data, and the first scan distance being less than the predetermined threshold, enter an unlocked state and perform the device ranging in association with the digital key exchange with the secured area.

4. The mobile device of claim 2, wherein the one or more processors are further configured to cause the mobile device to:
in response to the mobile device being in a locked state, the successful authentication of the first authentication data, and the first scan distance being greater than the predetermined threshold, enter an unlocked state and not initiate the device ranging in association with the digital key exchange with the secured area.

5. The mobile device of claim 4, wherein the one or more processors are further configured to cause the mobile device to:
in response to the mobile device being in the unlocked state and in response to receiving a predetermined gesture, receive, via the camera system and from a second scanning distance, second authentication data during a second scan event; and
in response to the successful authentication of the second authentication data and the second scanning distance associated with the second scan event being less than the predetermined threshold, perform the device ranging in association with the digital key exchange with the first secured area.

6. The mobile device of claim 5, wherein the predetermined gesture comprises at least one of:
a hardware gesture input by the user and received by the mobile device;
a software gesture input by the user and received by the mobile device; or
a combination of the hardware gesture and the software gesture input by the user and received by the mobile device.

7. The mobile device of claim 6, wherein the predetermined gesture further comprises the user raising the phone to a vertical orientation in front of a face.

8. The mobile device of claim 5, wherein the second scan event occurs a predetermined time after receiving the predetermined gesture.

9. The mobile device of claim 1, wherein the authentication data includes data associated with a facial scan or an iris scan.

10. The mobile device of claim 1, wherein the scanning distance is determined based on a time-of-flight measurement using an infrared (IR) light sensor or based on an inferred depth position using a diffractive optical element screen associated with the camera system.

11. The mobile device of claim 1, wherein the one or more processors are further configured to cause the mobile device to:
in response to the device ranging indicating that the mobile device is within a predetermined distance of the secured area, transmit a digital key associated with the secured area to a receiver associated with the secured area to unlock the secured area.

12. The mobile device of claim 1, wherein the secured area comprises an automobile, a lock, a locker, a security system, a hotel room, or a smart home device.

13. The mobile device of claim 1, wherein the mobile device comprises a smartphone, a mobile phone, or a smartwatch.

14. A method comprising:
receiving, via a camera system and from a scanning distance, authentication data during a scan event; and
in response to successfully authenticating the authentication data and the scanning distance being less than a predetermined threshold, performing device ranging in association with a digital key exchange with a secured area.

15. The method of claim 14, wherein:
the authentication data includes data associated with a facial scan or an iris scan; and
the scanning distance is determined based on a time-of-flight measurement using an infrared (IR) light sensor or based on an inferred depth position using a diffractive optical element screen associated with the camera system.

16. The method of claim 14, wherein:
the authentication data is first authentication data received during a first scan event at a first scan distance; and
the method further comprises, in response to the mobile device being in a locked state, the successful authentication of the first authentication data, and the first scan distance being less than the predetermined threshold, entering an unlocked state and performing the device ranging in association with the digital key exchange with the secured area.

17. The method of claim 14, wherein:
the authentication data is first authentication data received during a first scan event at a first scan distance; and
the method further comprises, in response to the mobile device being in a locked state, the successful authentication of the first authentication data, and the first scan distance being greater than the predetermined threshold, entering an unlocked state and not initiating the device ranging in association with the digital key exchange with the secured area.

18. The method of claim 17, wherein the method further comprises:
in response to the mobile device being in the unlocked state and in response to receiving a predetermined gesture, receiving, via the camera system and from a second scanning distance, second authentication data during a second scan event; and
in response to the successful authentication of the second authentication data and the second scanning distance associated with the second scan event being less than the predetermined threshold, performing the device ranging in association with the digital key exchange with the first secured area.

19. The method of claim 18, wherein:
the predetermined gesture comprises at least one of:
a hardware gesture input by the user and received by the mobile device;
a software gesture input by the user and received by the mobile device; or
a combination of the hardware gesture and the software gesture input by the user and received by the mobile device.

20. A system comprising:
at least one memory; and
at least one processor coupled with the at least one memory and configured to cause the system to:
receive, via a camera system and from a scanning distance, authentication data during a scan event; and
in response to successful authentication of the authentication data and the scanning distance being less than a predetermined threshold, perform device ranging in association with a digital key exchange with a secured area.
